(19) United States
(12) Patent Application Publication
(10) Pub. No.: US 2015/0321663 A1
(43) Pub. Date: Nov. 12, 2015

(54) FAIL SAFE METHOD OF ENGINE CLUTCH ACTUATOR OF HYBRID VEHICLE EQUIPPED WITH DUAL CLUTCH

(71) Applicants: HYUNDAI MOTOR COMPANY, Seoul (KR); KIA MOTORS CORPORATION, Seoul (KR)

(72) Inventors: Young Chul Kim, Gwangmyeong (KR); Tae Ho Kim, Seoul (KR); Jong Hyun Kim, Suwon (KR); Hak Sung Lee, Gunpo (KR); Jang Mi Lee, Tongyeong (KR)

(21) Appl. No.: 14/558,758

(22) Filed: Dec. 3, 2014

(30) Foreign Application Priority Data
May 9, 2014 (KR) 10-2014-0055388

(51) Int. Cl. B60W 20/00; B60W 10/06; B60W 10/02

(52) U.S. Cl. CPC B60W 20/50; B60W 20/40; B60W 10/02; B60W 10/06; B60W 2510/0638; B60W 2710/021; Y10S 903/93

(57) ABSTRACT

A fail safe method of an actuator includes determining whether a vehicle is travelling in an electric vehicle (EV) mode when an actuator fail of an engine clutch of the vehicle is generated, determining whether a returning operation of returning the actuator to a home position is possible when it is determined that the vehicle is travelling in the EV mode, connecting the engine clutch when it is determined that the returning operation of the actuator is possible, and driving the vehicle in a hybrid electric vehicle (HEV) mode.

### CROSS-REFERENCE TO RELATED APPLICATION

This application claims under 35 U.S.C. §119(a) the benefit of Korean Patent Application No. 10-2014-0055388 filed on May 9, 2014, the entire contents of which are incorporated herein by reference.

### BACKGROUND

1. Technical Field

The present disclosure relates to a fail safe method of an engine clutch actuator of a hybrid electric vehicle. More particularly, it relates to a fail safe method by controlling a speed of an engine clutch motor and revolutions per minute (RPM) of an engine of a hybrid electric vehicle when an actuator fail is generated.

2. Background Art

As is generally known, a hybrid vehicle is a vehicle using two or more types of power sources, and generally refers to a hybrid electric vehicle driven by using an engine and a motor. That is, the hybrid electric vehicle may form various structures with two or more power sources configured by the engine and the motor.

To this end, a driving mode of the hybrid electric vehicle can be divided into an electric vehicle (EV) mode and a hybrid electric vehicle (HEV) mode. A hybrid electric vehicle in the EV mode refers to an electric vehicle driven purely by an electric motor/battery. This is advantageous in that the electric vehicle may travel without requiring the driving force of an internal combustion engine. Meanwhile, a vehicle adopting the HEV mode, i.e., the hybrid electric vehicle mode, refers to a vehicle generating driving rotation force with both an internal combustion engine and an electric motor.

In a transmission system of a hybrid vehicle, a dual clutch transmission may be used. When using the dual clutch transmission, rotation force input from the engine and the motor is selectively transmitted to two input shafts by using two clutches, and the two clutches are mounted with an automatic transmission mechanism in an existing manual transmission so as to shift and output a gear stage by using rotation force of gears disposed at the two input shafts, thereby maintaining excellent efficiency of the manual transmission while achieving convenience of the automatic transmission.

Further, the dual clutch transmission is used in hybrid vehicles, meaning that the engine clutch is controlled by a separate actuator. In the related art, when a fail is generated, such as power cutoff of an engine clutch actuator, the actuator typically fixes a piston. Then, the actuator stores a position of the piston just before the fail occurs in a higher controller by using a position sensor, and the hybrid vehicle travels while maintaining a driving mode in the fail stage. However, when the actuator is returned to a home position, a different fail safe method is demanded when a fail is generated by power cutoff of the actuator.

The above information disclosed in this Background section is only for enhancement of understanding of the background of the disclosure, and therefore it may contain information that does not form the related art.

### SUMMARY OF THE DISCLOSURE

An engine clutch is controlled by a separate actuator when using a dual clutch transmission in a hybrid vehicle. Accordingly, in cases where an actuator fail occurs during an electric vehicle (EV) driving mode of a hybrid vehicle, the driving mode of the hybrid vehicle may be switched to a hybrid electric vehicle (HEV) mode while the actuator is returned to a home position.

When the switch to the HEV mode is performed, the engine is not ignited, such that a secondary fail of the engine and the transmission may be caused together with a large impact through connection of the engine clutch. Further, in the fail safe method of fixing the piston, the actuator fail is generated while the vehicle travels in the EV mode in order to fix the piston, and the vehicle travels in the EV mode, so that there is a risk in that the battery is discharged.

In order to solve the aforementioned problem, an object of the present disclosure is to provide a vehicle that can switch from an EV mode to an HEV mode by returning the actuator to a home position when an actuator fail is generated while driving in the EV mode. Further, in switching the EV mode to the HEV mode by returning the actuator to the home position when the actuator fail is generated, in order to prevent a secondary fail of the engine and transmission, the RPM of the engine may be controlled according to a speed of the motor of the engine clutch. In controlling the RPM of the engine, an increasing time of the RPM of the engine can be determined according to a torque transmission time during the movement of the stroke of the actuator. The time is determined by learning a compensation value when abrasion of the actuator is generated, and a value of the increasing time, on which abrasion compensation is performed, is stored.

Accordingly, the present disclosure allows for setting an RPM of the engine and minimizing an impact applied to the engine or the transmission after the actuator fail according to the set RPM of the engine. When the actuator fail is generated, it is possible to drive the vehicle by switching the EV mode to the HEV mode. Also, the engine is in an off state during the process of switching the EV mode to the HEV mode, so that a large impact may be generated while the engine clutch is connected, and a secondary fail may be generated in the engine and the transmission by the impact.

Accordingly, it is possible to smoothly connect the engine clutch by setting an RPM of the engine according to a speed of the engine clutch of the motor, thereby minimizing an impact when the actuator is returned. Further, it is possible to prevent the generation of the secondary fail of the engine and the transmission. Moreover, it is possible to minimize the impact when the actuator is returned, thereby improving safety for a driver, and marketability of a vehicle. Even further, when a piston is fixed regardless of the possibility of returning of the actuator to a home position when the actuator fail is generated, there is a problem in that a battery is discharged during driving in the EV mode, but when the vehicle travels by switching the EV mode to the HEV mode, it is possible to solve this discharge problem of the battery.

The above and other features of the disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a flowchart illustrating a fail safe method according to the present disclosure applied to a case where an actuator fail is generated while a vehicle travels in an EV mode;

FIG. 2 is a flowchart illustrating a process of controlling a connection of an engine clutch through control of an RPM of an engine;

FIG. 3 is a flowchart illustrating a process of storing a time (t_s) according to leaning;

FIG. 4 is a flowchart illustrating an actuator control method considering abrasion compensation of an actuator during the learning of the time (t_s); and

FIG. 5 is a graph illustrating a clutch transmission torque and a time according to a stroke position while returning the actuator.

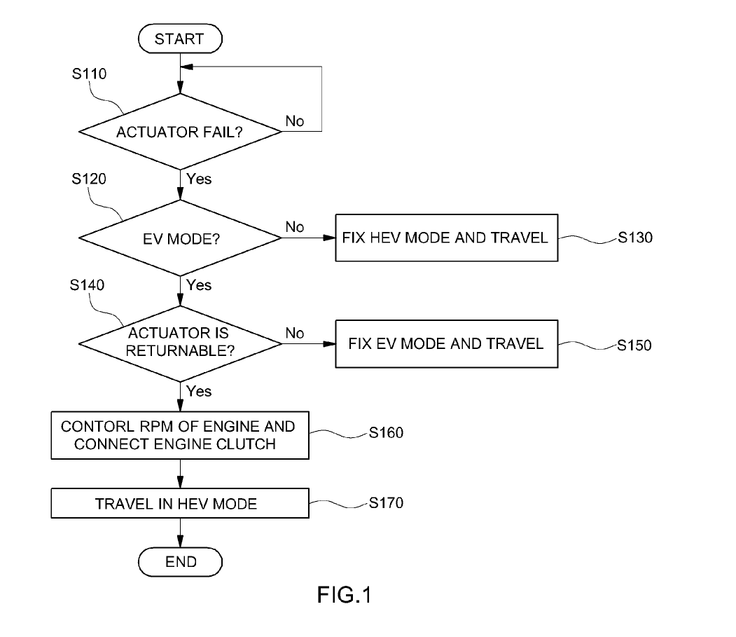

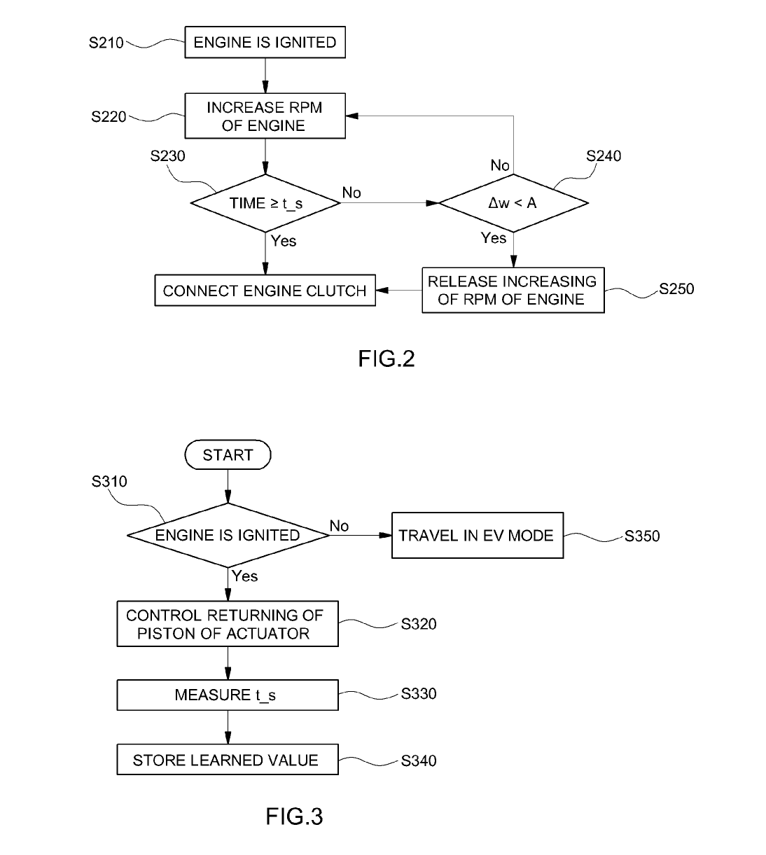

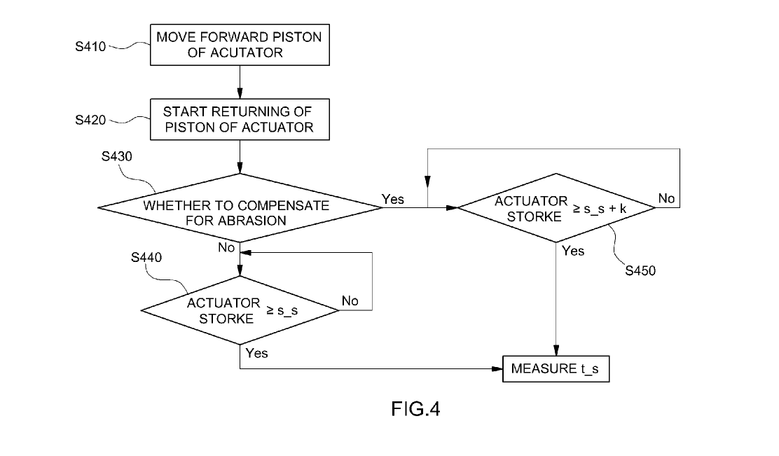

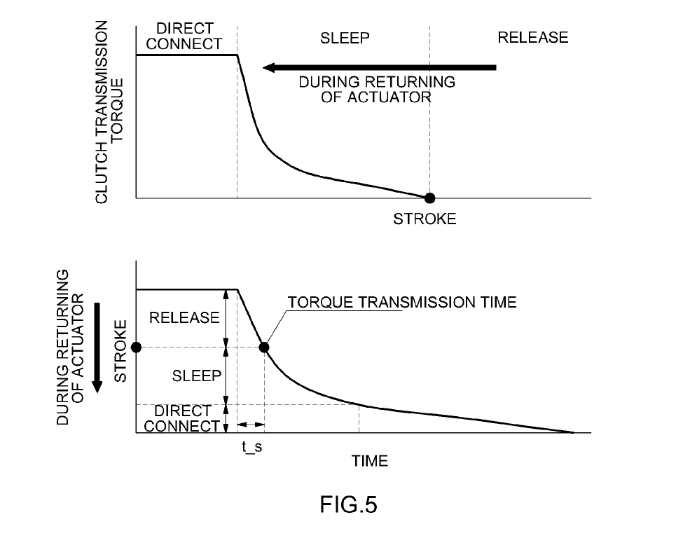

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter reference will now be made in detail to various embodiments of the present disclosure, examples of which are illustrated in the accompanying drawings and described below. While the disclosure will be described in conjunction with exemplary embodiments, it will be understood that the present description is not intended to limit the disclosure to those exemplary embodiments. On the contrary, the disclosure is intended to cover not only the exemplary embodiments, but also various alternatives, modifications, equivalents and other embodiments, which may be included within the spirit and scope of the disclosure as defined by the appended claims.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

Additionally, it is understood that the below methods may be executed by at least one control unit. The term “control unit” refers to a hardware device that includes a memory and a processor. The memory is configured to store program instructions, and the processor is configured to execute the program instructions to perform one or more processes which are described further below. Moreover, it is understood that the below methods may be executed by a system comprising the control unit, whereby the control unit is known in the art to be suitable for performing a fail safe method of an engine clutch actuator of a vehicle, as is described in detail herein.

Furthermore, the control unit of the present disclosure may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

Hereinafter, an exemplary embodiment of a fail safe method of an engine clutch actuator of a hybrid vehicle equipped with a dual clutch transmission of the present disclosure will be described in detail with reference to the accompanying drawings.

An engine clutch of a hybrid vehicle using a dual clutch transmission is controlled by an actuator. When the actuator fail of the engine clutch is generated during the driving in the EV mode, the battery may be discharged when the EV mode is maintained, and even when an actuator fail by an electric signal is generated, the actuator may be mechanically returned to a home position, so that a switch from the EV mode to the HEV mode is demanded.

However, in the fail safe method of switching the EV mode to the HEV mode, an impact is generated during the returning of the actuator to the home position in the case of the actuator fail generated in the EV mode, so that a secondary impact may be generated in the engine and the transmission. In order to prevent the secondary impact, the present disclosure provides a fail safe method of controlling the RPM of an engine and connecting an engine clutch during a switch from the EV mode to the HEV mode.

In the case of an actuator fail (S110), the actuator may be returned to a home position (S140). As an example, in cases where the actuator may be returned to the home position, such as an engine ignition inability state or a CAN communication fail, the fail safe method of the actuator is operated. Accordingly, the present disclosure relates to a fail safe method of an actuator, by which the actuator may be returned to a home position even in cases where a fail is generated in the actuator.

In the case of the engine clutch actuator, a transmission torque of the engine clutch is increased during the returning of the actuator to the home position, and the engine clutch is directly connected. Accordingly, in the returning process of the actuator, a release process, a sleep process, and a direct connection process of the engine clutch are sequentially performed, and a torque transmission start point is presented at a section at which the release stage moves on the sleep stage. In FIG. 5, a clutch transmission torque during the returning of the actuator, and a connection stage of the engine clutch can be seen.

The engine clutch has a point (s_s) at which the release stage moves on the sleep stage while a piston of the actuator moves forward and then is returned in a learning state of a time (t_s) of the present invention. The point (s_s) may be considered as the torque transmission start point. Accordingly, when the time (t_s) is measured, the point at which the release stage of the engine clutch moves on the sleep stage during the returning of the actuator may be the torque transmission start point (s_s), and a time from a release time of the engine clutch after the start of the returning of the actuator to the torque transmission time may be considered as the time (t_s).

Further, when abrasion of the engine clutch is generated, the torque transmission start point is considered by adding an abrasion compensation value (k), so that the torque transmission start point is determined as a time (s_s+k). As an exemplary embodiment, when an actuator fail is generated while travelling in the EV mode (S120), it is determined whether the actuator is returned to a home position (S140). However, when the vehicle travels in the HEV mode, not the EV mode, the vehicle is fixed in the HEV mode and continues travelling (S130).

When the actuator fail is generated while travelling in the EV mode, and a fail that the actuator cannot be returned is generated, revolutions per minute (RPM) of the engine are controlled (160), thereby making the engine clutch be smoothly connected. However, when the actuator of the engine clutch cannot be returned to a home position, the vehicle is fixed in the EV mode (S150), and then continues travelling. Accordingly, the hybrid vehicle travels (S170) by switching the EV mode to the HEV mode through the connection of the engine clutch.

In operation S160 of controlling the RPM of the engine, increasing of the RPM of the engine during the start of the engine is performed (S220). An amount of time for which the RPM of the engine is increased (e.g., the “increasing time”) is based on the pre-stored time (t_s). Accordingly, when the increasing time of the RPM of the engine is equal to or greater than the time (t_s) (S230), the engine clutch is connected. However, even in cases where the increasing time of the RPM of the engine is smaller than the time (t_s), when a difference (ΔW ) between the RPM of the engine and a speed of a motor of the engine clutch reaches a range of a predetermined value (A) (S240), the increasing of the RPM of the engine is released (S250), and the engine clutch is connected.

A learning method of the time (t_s) is performed by controlling the returning of the piston of the actuator in an engine ignition state (S320). For example, when the engine is ignited (S310), the piston of the actuator is moved forward (S410), and then a value of the movement time (t_s) to the torque transmission start time (s_s) is learned through the returning of the piston of the actuator (S420). However, when the engine is not ignited in the learning stage, the vehicle is maintained in the EV mode to travel (S350).

In the case of the control of the piston of the actuator (S320), whether abrasion compensation is demanded is determined (S430). When the abrasion compensation is not demanded, whether the actuator moves for the torque transmission start time or more during a stroke operation is determined (S440). When the actuator moves for the torque transmission start time or more during the stroke operation, a time (t_s) from the release time of the actuator to the torque transmission start time (s_s) may be measured. The learned value of the time (t_s) is then set as a reference value of the increasing time of the RPM of the engine.

When it is determined that the actuator abrasion is generated, it is determined whether the actuator moves for the torque transmission start point (s_s+k), on which the abrasion compensation (k) is performed, or more during the stroke operation (S450), and when the actuator moves to the torque transmission start point (s_s+k) on which the abrasion compensation (k) is performed, or more, during the stroke operation, the time (t_s) may be measured. Similarly, the value of the learned time (t_s) is then set as a reference value of an increasing time of the RPM of the engine. Notably, is possible to determine an increasing time of the RPM of the engine through the stored value of the time (t_s) through the learning, so that it is possible to smoothly connect the engine clutch through matching a speed of the motor of the engine clutch and the RPM of the engine.

The contents of the present disclosure have been described in detail with reference to preferred embodiments thereof. However, it will be appreciated by those skilled in the art that changes may be made in these embodiments without departing from the principles and spirit of the disclosure, the scope of which is defined in the appended claims and their equivalents.

What is claimed is:

1. A fail safe method of an actuator, comprising:
a) determining whether a vehicle is travelling in an electric vehicle (EV) mode when an actuator fail of an engine clutch of the vehicle is generated;
b) determining whether a returning operation of returning the actuator to a home position is possible when it is determined that the vehicle is travelling in the EV mode;
c) connecting the engine clutch when it is determined that the returning operation of the actuator is possible; and
d) driving the vehicle in a hybrid electric vehicle (HEV) mode.

2. The fail safe method of claim 1, wherein the operation c) includes:
c1) igniting an engine;
c2) increasing revolutions per minute (RPM) of the engine through an ignition of the engine;
c3) determining whether the RPM of the engine has increased for an amount of time that is equal to or greater than a pre-learned time; and
c4) when the RPM of the engine has increased for an amount of time that is equal to or greater than the pre-learned time, connecting the engine clutch.

3. The fail safe method of claim 2, wherein the operation c3) includes:
c31) moving a piston of the actuator forwardly when the engine is ignited;
c32) controlling the returning of the piston of the actuator; and
c33) measuring and storing a movement time of the piston as a torque transmission start time of the actuator during the controlling of the returning of the piston of the actuator.

4. The fail safe method of claim 3, wherein operation c32) includes:
starting the returning of the piston of the actuator;
checking whether to compensate for abrasion of the actuator; and
determining whether the actuator moves for the torque transmission start time or more during the returning of a stroke of the actuator when the abrasion of the actuator is compensated.

5. The fail safe method of claim 4, wherein the checking of whether to compensate for abrasion of the actuator includes determining whether the actuator moves for the torque transmission start time or more during the returning of the stroke of the actuator when abrasion compensation is not demanded during the returning of the stroke of the actuator.

6. The fail safe method of claim 2, comprising:
when the RPM of the engine is increased for an amount of time that is smaller than the pre-learned time, determining whether a difference between the RPM of the engine and a speed of a motor of the engine clutch is within a range of a predetermined value.

7. The fail safe method of claim 6, comprising:
when the difference between the RPM of the engine and the speed of the motor of the engine clutch is within the range of the predetermined value, releasing the increasing of the RPM of the engine; and
connecting the engine clutch when the increasing of the RPM of the engine is released.

8. The fail safe method of claim 1, comprising:
driving the vehicle in the HEV mode when the vehicle is not travelling in the EV mode.

9. The fail safe method of claim 1, comprising:
driving the vehicle in the EV mode when the returning operation of the actuator is impossible.

10. The fail safe method of claim 1, wherein the actuator fail of the vehicle includes at least one of an ignition impossible state of an engine and a controller area network (CAN) communication fail.

11. The fail safe method of claim 3, comprising:
maintaining the EV mode when the engine is not ignited.

12. A fail safe system of an actuator performed by a control unit that is configured to:
a) determine whether a vehicle is travelling in an electric vehicle (EV) mode when an actuator fail of an engine clutch of the vehicle is generated;
b) determine whether a returning operation of returning the actuator to a home position is possible when it is determined that the vehicle is travelling in the EV mode;
c) connect the engine clutch when it is determined that the returning operation of the actuator is possible; and
d) drive the vehicle in a hybrid electric vehicle (HEV) mode.

13. A non-transitory computer readable medium containing program instructions for a fail safe method of an actuator, the computer readable medium comprising:
a) program instructions that determine whether a vehicle is travelling in an electric vehicle (EV) mode when an actuator fail of an engine clutch of the vehicle is generated;
b) program instructions that determine whether a returning operation of returning the actuator to a home position is possible when it is determined that the vehicle is travelling in the EV mode;
c) program instructions that connect the engine clutch when it is determined that the returning operation of the actuator is possible; and
d) program instructions that drive the vehicle in a hybrid electric vehicle (HEV) mode.
